(19) United States
(12) Patent Application Publication
(10) Pub. No.: US 2010/0250080 A1
(43) Pub. Date: Sep. 30, 2010

(54) CONTROL APPARATUS FOR AUTOMATED MANUAL TRANSMISSION

(75) Inventors: Shuichi DOMAE, Nishio-shi (JP); Atsushi Takeuchi, Nagoya-shi (JP); Kiyoshi Nagami, Nishio-shi (JP); Takeshige Miyazaki, Chiryu-shi (JP); Yoshiki Ito, Nukata-gun (JP); Hiroki Hatori, Nishio-shi (JP); Hiroshi Toyoda, Nishio-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI CO., LTD., Nishio-shi (JP)

(21) Appl. No.: 12/750,028

(22) Filed: Mar. 30, 2010

(30) Foreign Application Priority Data
Mar. 31, 2009 (JP) 2009-085861

(51) Int. Cl. G06F 19/00

(52) U.S. Cl. 701/68

(57) ABSTRACT

A control apparatus for an automated manual transmission having a plurality of power transmitting units respectively including clutches for connecting and disconnecting a power transmission path between a power source and the automated manual transmission and transmission mechanisms connected to the corresponding clutches so as to transmit a power of the power source, includes a clutch temperature calculating means for calculating a temperature of each of the clutches, and a vehicle moving start controlling means for controlling a moving start of the vehicle so that when the temperature of one of the clutches, calculated by means of the clutch temperature calculating means, is equal to or higher than a predetermined usage restriction threshold value, the other one of the clutches is used so as to transmit the power of the power source to the other one of the power transmission units, having the other one of the clutches.

### CROSS REFERENCE TO RELATED APPLICATIONS

This application is based on and claims priority under 35 U.S.C. §119 to Japanese Patent Application 2009-085861, filed on Mar. 31, 2009, the entire content of which is incorporated herein by reference.

### TECHNICAL FIELD

This disclosure relates to a control apparatus for an automated manual transmission.

### BACKGROUND DISCUSSION

A known automated manual transmission, mounted on a vehicle, is disclosed in, for example, JP2007-232047A. The automated manual transmission according to JP2007-232047A is a dual-clutch type transmission, which includes two power transmission units (a first power transmission unit and a second power transmission unit). The first power transmission unit includes a first clutch and a first transmission mechanism, which includes odd-number shift stage gear sets (a first shift stage gear set, a third shift stage gear set and a fifth shift stage gear set) and which is connected to the first clutch so as to enable a power transmission therebetween. The second power transmission unit includes a second clutch and a second transmission mechanism, which includes even-number shift stage gear sets (a second shift stage gear set, a fourth shift stage gear set, a sixth shift stage gear set) and which is connected to the second clutch so as to enable a power transmission therebetween. In order to drive the vehicle at the first shift stage, for example, the first shift stage gear sets are set in the first transmission mechanism, the first clutch is switched to an engaged state, and the power of an engine, serving as a power source, is transmitted by means of the first power transmission unit to driving wheels, and thereby the vehicle is driven. When the vehicle is driven at the first shift stage, the second clutch of the second power transmission unit is in a disengaged state, and the power of the engine is not transmitted to the second power transmission unit.

According to the vehicle, on which the above-described automated manual transmission is mounted, both of the first and second clutches are in the disengaged state while a brake pedal of the vehicle is being operated by a driver so as to stop the vehicle. Then, when the operation of the brake pedal is canceled, the first clutch is switched into a half-engaged state where the power of the engine is slightly transmitted. Subsequently, when an accelerator is operated, the first clutch is switched into the engaged state where the power of the engine is sufficiently transmitted, and thereby the vehicle is started to move.

Generally, a frequent switching of the clutch between the engaged state and the disengaged state may cause a generation of frictional heat and a temperature increase of the clutch. In order to deal with such a drawback, according to an automated manual transmission, disclosed in JP2006-001338A, when the temperature of the first clutch increases to an excessively high level (i.e. when the first clutch is overheated), a control device of the automated manual transmission outputs a command signal for releasing the first clutch, and thereby restricting a usage of the first clutch until the temperature thereof drops sufficiently. Further, the control device outputs a command signal for driving a brake actuator so as to restrict a rearward movement of the vehicle (for example, sliding down of the vehicle driving up on a slope).

However, according to the control device of the automated manual transmission, disclosed in JP2006-001338A, when the first clutch is overheated, the usage of the first clutch is restricted until the temperature thereof drops and the overheated state ends. Therefore, even when the driver, having an intention of starting to move the vehicle, operates an accelerator pedal, regardless of the intention of the driver, the vehicle may not be started to move because switching of the first clutch to the engaged state is restricted.

A need thus exists for a control apparatus for an automated manual transmission, which is not susceptible to the drawback mentioned above.

### SUMMARY

According to an aspect of this disclosure, a control apparatus for an automated manual transmission having a plurality of power transmitting units respectively including clutches for connecting and disconnecting a power transmission path between a power source and the automated manual transmission and transmission mechanisms connected to the corresponding clutches so as to transmit a power of the power source, the control apparatus includes a clutch controlling means for controlling switching of one of the clutches, provided to one of the power transmission units, to an engaged state and the other one of the clutches, provided to the other one of the power transmission units, to a disengaged state, in order to transmit the power of the power source to the power transmission units, having the clutch in the engaged state, when a vehicle is being driven, a clutch temperature calculating means for calculating a temperature of each of the clutches, and a vehicle moving start controlling means for controlling a moving start of the vehicle so that when the temperature of one of the clutches, calculated by means of the clutch temperature calculating means, is equal to or higher than a predetermined usage restriction threshold value, the other one of the clutches is used so as to transmit the power of the power source to the other one of the power transmission units, having the other one of the clutches.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram illustrating a vehicle, on which an automated manual transmission according to an embodiment is mounted;

FIG. 2 is a skeleton diagram illustrating the automated manual transmission according to the embodiment;

FIG. 3 is a flowchart illustrating a routine of a vehicle moving starting process;

FIG. 4 is a flowchart illustrating a routine of a clutch overheat determination process;

FIG. 5 is a flowchart illustrating a routine of a first clutch overheat determination process; and

FIG. 6 is a flowchart illustrating a routine of a second clutch overheat determination process.

### DETAILED DESCRIPTION

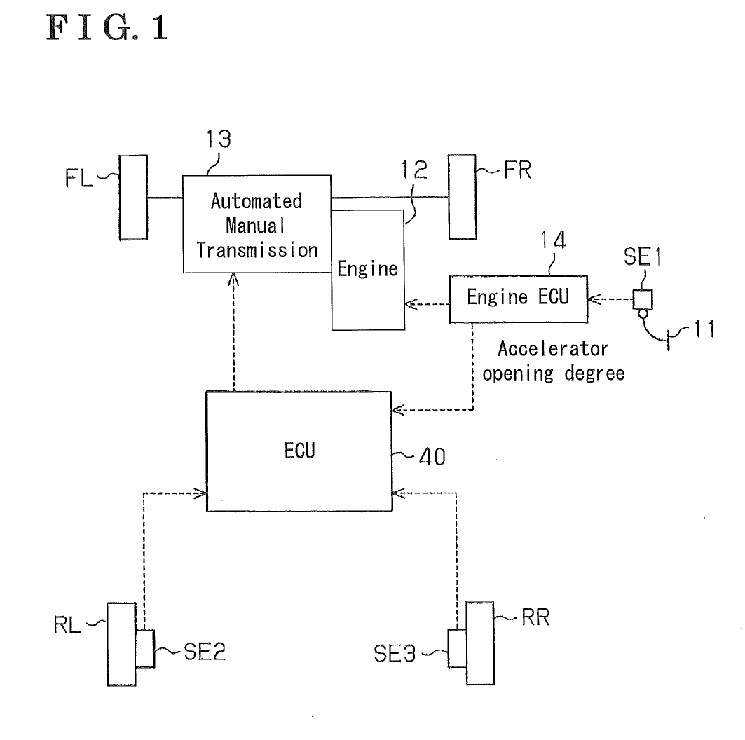

An embodiment of a control apparatus for an automated manual transmission, mounted on a vehicle, will be described hereinafter with reference to FIGS. 1 to 6. As illustrated in FIG. 1, the vehicle includes a plurality of wheels (four wheels according to the embodiment) (a front-right wheel FR, a front-left wheel FL, a rear-right wheel RR and a rear-left wheel RL), which contact a road surface while the vehicle is being driven. The vehicle is a front-wheel-drive vehicle where the front wheels FR and FL serve as driving wheels and the rear wheels RR and RL serve as driven wheels. The vehicle further includes an engine 12 (a driving source), which generates a power (torque), depending on a depressing amount of an accelerator pedal 11, operated by a driver. The power, generated by the engine 12, is transmitted to the front wheels FR and FL through an automated manual transmission 13 and the like. The vehicle further includes an electronic control device (which will be referred to as an engine ECU 14 hereinafter), which controls a driving of the engine 12, depending on an operation of the accelerator pedal 11 by the driver. An accelerator sensor SE1 for detecting an opening degree of the accelerator pedal 11 (an accelerator opening degree) is electrically connected to the engine ECU 14. The engine ECU 14 calculates the accelerator opening degree on the basis of a detection signal, outputted from the accelerator sensor SE1, and then transmits information on a result of the calculation to an ECU 40 (described later) of the automated manual transmission 13.

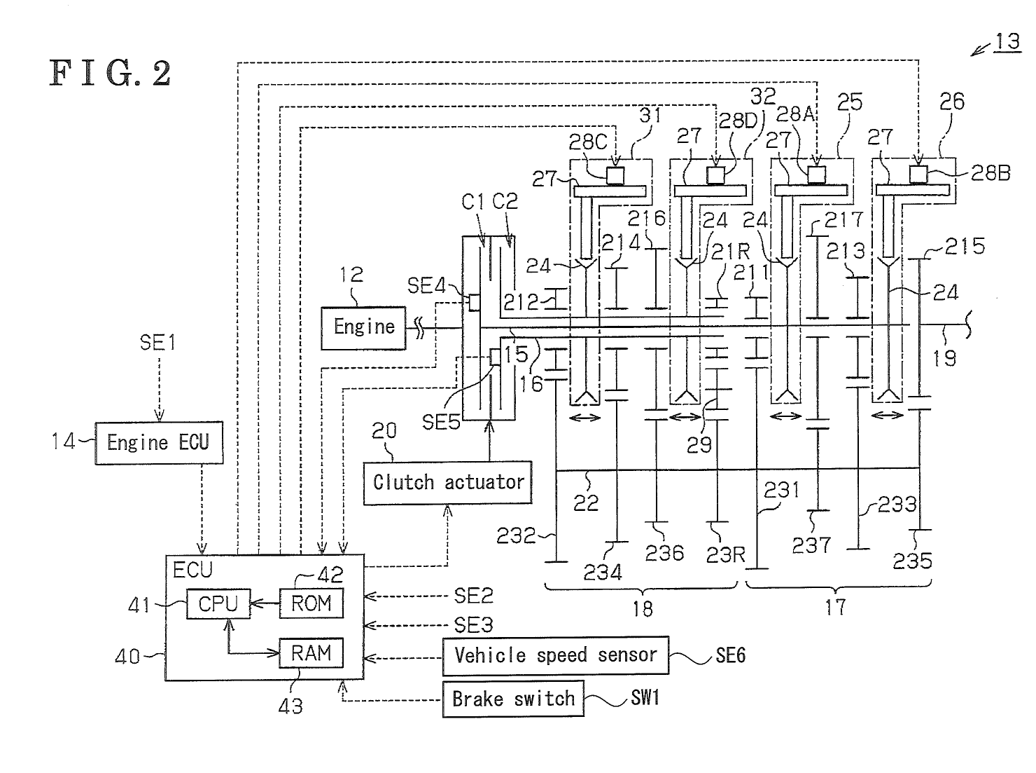

The automated manual transmission will be described hereinafter with reference to FIG. 2. As illustrated in FIG. 2, the automated manual transmission 13 is a dual-clutch transmission having seven forward movement shift stages and one rearward movement shift stage. The automated manual transmission 13 includes a plurality of clutches (two clutches according to the embodiment) (a first clutch C1 and a second clutch C2), a first input shaft 15 connected to the first clutch, a second input shaft 16 connected to the second clutch C2, a first gear transmission mechanism (a transmission mechanism) 17 for establishing odd-number shift stages (a first shift stage, a third shift stage, a fifth shift stage and a seventh shift stage), a second gear transmission mechanism 18 for establishing even-number shift stages (a second shift stage, a fourth shift stage, a sixth shift stage) and a rearward movement shift stage, and an output shaft 19 provided so as to be rotatable coaxially with the first and second input shafts 15 and 16.

The first input shaft 15 is formed into a substantially rod shape extending from the first clutch C1 to a predetermined direction (from left to right direction in FIG. 2). When a clutch actuator 20 is driven and the first clutch C1 is switched into an engaged state, the first input shaft 15 rotates about a rotational axis, which extends in the predetermined direction. The second input shaft 16 is formed into a substantially hollow-cylindrical shape extending from the second clutch C2 to the predetermined direction (from left to right direction in FIG. 2). A portion of the first input shaft close to the first clutch C1 is accommodated in the second input shaft 16. When the clutch actuator 20 is driven so that the second clutch C2 is switched into an engaged state, the second input shaft 16 rotates coaxially with the first input shaft 15. An engaged state of the first clutch C1 hereinafter will refer to a state where an input side (a side where a power of the engine is inputted) of the first clutch C1 an output side (a side where the power of the engine is outputted to the automated manual transmission 13) thereof are engaged with each other. A disengaged state of the first clutch C1 hereinafter will refer to a state where the engagement between the input side of the first clutch C1 and the output side thereof are released so that a power is not transmitted. Likewise, an engaged state of the second clutch C2 hereinafter will refer to a state where an input side (a side where a power of the engine is inputted) of the second clutch C2 and an output side (a side where the power of the engine is outputted to the automated manual transmission 13) thereof are engaged with each other. A disengaged state of the second clutch C2 hereinafter will refer to a state where the engagement between the input side of the second clutch C2 and the output side thereof are released so that a power is not transmitted.

The first gear transmission mechanism 17 includes odd-number shift stages (a first shift stage gear 211, a seventh shift stage gear 217 and a third shift stage gear 213), which are held by the first input shaft 15 so as to be relatively rotatable and are arranged in the mentioned order in a predetermined direction (in a left-to-right direction in FIG. 2), and a fifth shift stage gear 215, which is held by the output shaft 19 so as to be ratable integrally therewith. The first gear transmission mechanism 17 further includes a plurality of counter gears (four counter gears according to the embodiment) (a first counter gear 231, a third counter gear 233, a fifth counter gear 235 and a seventh counter gear 237), which are fixed at a counter gear 22, provided in parallel with the first and second input shafts 15 and 16, so as to be integrally rotatable therewith, and are engaged with the corresponding odd-number shift stage gears 211, 213, 215 and 217.

The first gear transmission mechanism 17 further includes a first shift stage selection mechanism 25 for selecting one of the first shift stage gear 211 and the seventh shift stage gear 217, and a second shift stage selection mechanism 26 for selecting one of the third shift stage gear 213 and the fifth shift stage gear 215. Each of the first and second shift stage selection mechanisms 25 and 26 includes a sleeve 24, which is formed into a substantially cylindrical shape and is arranged at an outer circumference of the first input shaft 15 so as to be integrally rotatable therewith. The sleeve 24 is movable between the shift stage gear (for example, the first shift stage gear 211), provided at one side (a left side in FIG. 2) in a predetermined direction, and the shift stage gear (for example, the seventh shift stage gear 217), provided at the other side (a right side in FIG. 2) in the predetermined direction.

Each of the first and second shift stage selection mechanisms 25 and 26 includes a driving portion 27 for moving the sleeve 24 in the predetermined direction. A driving force is applied to the driving portion 27 by means of each of a first selection actuator 28A and a second selection actuator 28B. According to such configuration, when the driving portion 27 is actuated so as to move the sleeve 24 either to a first engagement position, in which the sleeve 24 is engaged with the shift stage gear positioned at one side (the left side in FIG. 2) in the predetermined direction, or to a second engagement position, in which the sleeve 24 is engaged with the shift stage gear positioned at the other side (the right side in FIG. 2) in the predetermined direction, the shift stage gear, with which the sleeve 24 is engaged, is rotated integrally with the first input shaft 15. For example, when the sleeve 24 of the second shift stage selection mechanism 26 is positioned at the second engagement position, a power is transmitted from the first input shaft 15 to the fifth shift stage gear 215 via the sleeve 24. On the other hand, when the sleeve 24 is moved to a neutral position, in which the sleeve 24 is positioned between the shift stage gears provided at both sides in the predetermined direction, a power is not transmitted from the first input shaft 15 to the first, third, fifth and seventh shift stage gears 211, 213, 215 and 217 via the sleeve 24.

The second gear transmission mechanism (a transmission mechanism) 18 includes even-number shift stages (a second shift stage gear 212, a fourth shift stage gear 214, a sixth shift stage gear 216) and a rearward movement shift stage gear 21R, which are arranged in the mentioned order in the predetermined direction (in the left-to-right direction in FIG. 2). The second gear transmission mechanism 18 further includes a plurality of counter gears (four counter gears according to the embodiment) (a second counter gear 232, a fourth counter gear 234, a sixth counter gear 236 and a rearward movement counter gear 23R), which are fixed at the counter gear 22 so as to be integrally rotatable therewith, and which correspond to the even-number shift stage gears 212, 214, 216 and the rearward movement shift stage gear 23R. The second gear transmission mechanism 18 further includes an idler gear 29 at a position between the rearward movement shift gear 21R and the rearward movement counter gear 23R. The idler gear 29 is engaged with the rearward movement shift gear 21 R and with the rearward movement counter gear 23R. The idler gear 29 can transmit a power from the rearward movement shift gear 21R to the rearward movement counter gear 23R.

The second gear transmission mechanism 18 further includes a third shift stage selection mechanism 31 for selecting one of the second shift stage gear 212 and the fourth shift stage gear 214, and a fourth shift stage selection mechanism 32 for selecting one of the sixth shift stage gear 216 and the rearward movement shift stage gear 21R. Similar to the first and second shift stage selection mechanisms 25 and 26, each of the third and fourth shift stage selection mechanisms 31 and 32 includes the sleeve 24, which is arranged at an outer circumference of the second input shaft 16 so as to be integrally rotatable therewith, and the driving portion 27, to which a driving force is applied by means of a third selection actuator 28C and a fourth selection actuator 28D. When the driving portion 27 is actuated, the sleeve 24 of each of the third and fourth shift stage selection mechanisms 31 and 32 is moved to the first, second or neutral position. The shift stage gear (for example, the second shift stage gear 212), with which the sleeve 24 is engaged, is integrally rotatable with the second input shaft 16.

According to the configuration of the automated manual transmission 13, in order to drive the vehicle in a state where the shift stage is set to the first shift stage, the first and second selection actuators 28A and 28B are driven so that the sleeve 24 of the first shift stage selection mechanism 25 is moved to the first engagement position where the engagement with the first shift stage gear 211 is established and so that the sleeve 24 of the second shift stage selection mechanism 26 is moved to the neutral position. Then, the clutch actuator 20 is driven so that the first clutch C1 is switched to the engaged state and the second clutch C2 is switched to the disengaged state. Consequently, the power of the engine 12 is transmitted through the first clutch C1, the first input shaft 15, the first shift stage gear 211, the first counter gear 231, the counter shaft 22, the fifth counter gear 235, the output shaft 19 and the like, to the front wheels FR and FL, thereby driving the vehicle. According to the embodiment, a first power transmission unit is configured by the first clutch C1, the first input shaft 15 and the first gear transmission mechanism 17.

On the other hand, in order to drive the vehicle in a state where the shift stage is set to the second shift stage, the third and fourth selection actuators 28C and 28D are driven so that the sleeve 24 of the third shift stage selection mechanism 31 is moved to the first engagement position where the engagement with the second shift stage gear 212 is established and so that the sleeve 24 of the fourth shift stage selection mechanism 32 is moved to the neutral position. Then, the clutch actuator 20 is driven so that the second clutch C2 is switched to the engaged state and the first clutch C1 is switched to the disengaged state. Consequently, the power of the engine 12 is transmitted through the second clutch C2, the second input shaft 16, the second shift stage gear 212, the second counter gear 232, the counter shaft 22, the fifth counter gear 235, the output shaft 19 and the like, to the front wheels FR and FL, thereby driving the vehicle. According to the embodiment, a second power transmission unit is configured by the second clutch C2, the second input shaft 16 and the second gear transmission mechanism 18.

The electronic control device (ECU) 40, serving as a control apparatus for controlling a driving of the automated manual transmission 13, will be described hereinafter with reference to FIGS. 1 and 2. As illustrated in FIGS. 1 and 2, an interface of the ECU 40 is electrically connected to a first wheel speed sensor SE2 and a second wheel speed sensor SE3 for detecting wheel speeds of the rear wheel RR and RL, respectively, a first temperature sensor SE4 and a second temperature sensor SE5 for detecting temperatures of the first and second clutches C1 and C2, respectively, a vehicle speed sensor SE6 for detecting a speed of the vehicle and a brake switch SW1 for detecting whether or not a brake pedal of the vehicle is operated. The interface of the ECU 40 is further electrically connected to the clutch actuator 20 and the first to fourth selection actuators 28A to 28D. Further, the ECU 40 receives information, such as the accelerator opening degree sent from the engine ECU 14.

The ECU 40 includes a digital computer, configured by a CPU 41, a ROM 42, a RAM 43 and the like. Control programs (a vehicle moving starting process (described later) and the like) for controlling a driving of the clutch actuator 20 and the first to fourth selection actuators 28A to 28D, thereby controlling the automated manual transmission 13 and threshold values (a temperature difference threshold value, a frequency threshold value, a cooling determination time, a usage restriction threshold value (described later) and the like) are memorized in the ROM 42. Information (a temperature of each clutch, a temperature difference, a frequency of both overheat measurements, each elapsed time, the clutch selected when the vehicle is started to move previously, each overheat flag, a single clutch overheat flag, an alternate starting flag (described later) and the like), which is overwritten at a predetermined time interval while an ignition switch is ON, is memorized in the RAM 43.

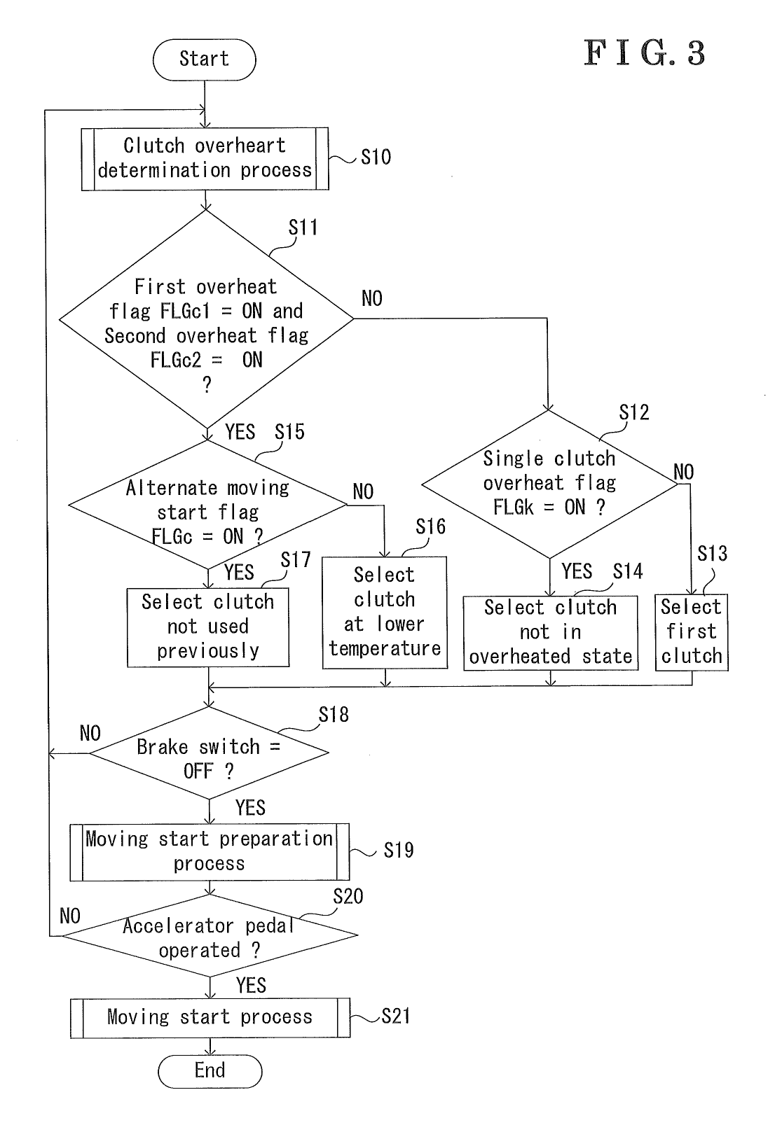

A routine of the vehicle moving starting process, executed by the ECU 40, will be described hereinafter with reference to flowcharts shown FIGS. 3 to 6. The vehicle moving starting process is repeatedly executed in every predetermined period when the vehicle is stopped (more specifically, when the vehicle speed is slower than a predetermined speed (for example 5 km/h)).

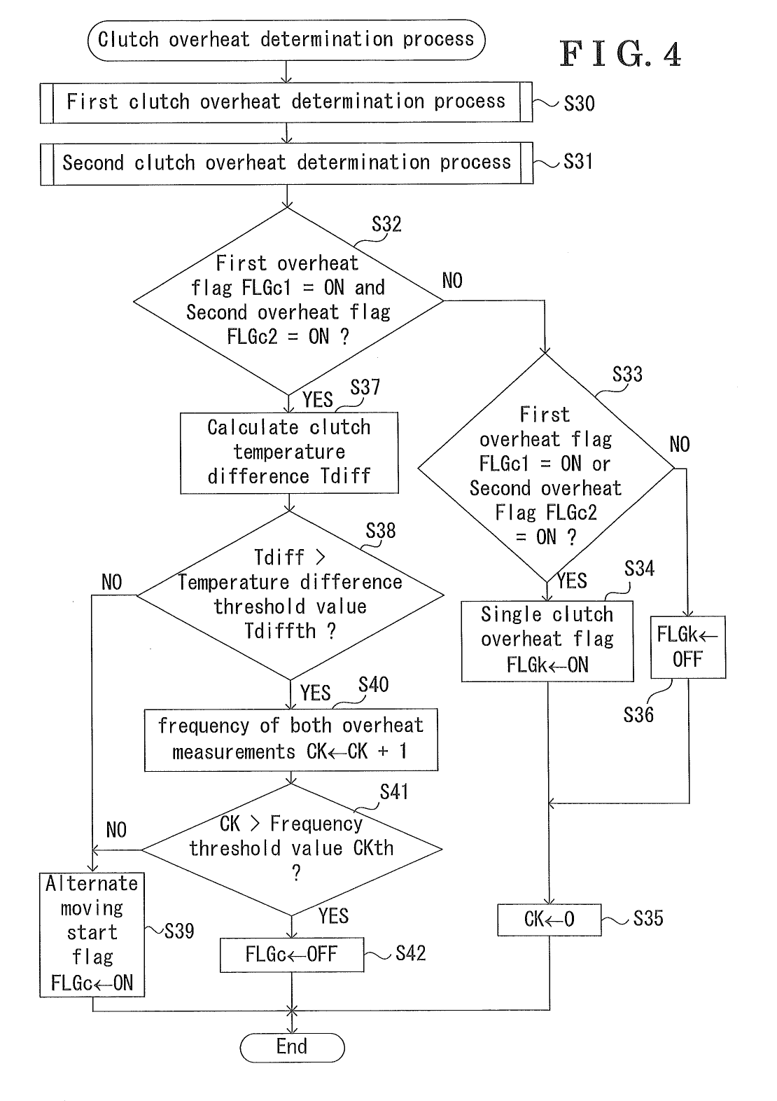

In the routine of the vehicle moving starting process, the ECU 40 executes a clutch overheat determination process (described in detail in FIG. 4) for detecting the overheated state of each of the first and second clutches C1 and C2 (Step 10, S10). In the clutch overheat determination process, each flag is set according to the temperature of each of the first and second clutches C1 and C2. Then, the ECU 40 determines whether or not both of a first overheat flag FLGc1 and a second overheat flag FLGc2 are set to ON (Step 11, S11). The first overheat flag FLGc1 is set to ON when the first clutch C1 is in an overheated state where the temperature thereof is excessively high. Further, the first overheat flag FLGc1 is set to OFF when the first clutch C1 is not in the overheated state. Likewise, the second overheat flag FLGc2 is set to ON when the second clutch C2 is in an overheated state where the temperature thereof is excessively high. Further, the second overheat flag FLGc2 is set to OFF when the second clutch C2 is not in the overheated state.

When a determination result of Step 11 is NO (in other words, at least one of the first and second overheat flag FLGc1 and FLGc2 is set to OFF), the ECU 40 determines whether or not the single clutch overheat flag FLGk is set to ON (Step 12, S12). The single clutch overheat flag FLGk is set to ON when one of the first and second clutches C1 and C2 is not in the overheated state. Further, the single clutch overheat flag FLGk is set to OFF when both of the first and second clutches C1 and C2 are or are not in the overheated state. When a determination result of Step 12 is NO (FLGk=OFF), the ECU 40 selects the first clutch C1 as a clutch selected when vehicle is started to move (which will be referred to as “a selected clutch” hereinafter) (Step 13, S13), and then the ECU 40 moves the process to Step 18 (described later). On the other hand, when the determination result of Step 12 is YES (FLGk=ON), the ECU 40 selects one of the first and second clutches C1 and C2, which is not in the overheated state, as the selected clutch (Step 14, S14), and then the ECU 40 moves the process to Step 18 (described later).

On the other hand, when the determination result of Step 11 is YES (both of FLGc1 and FLGc2 are ON), the ECU 40 determines whether or not the alternate moving start flag FLGc is ON (Step 15, S15). The alternate moving start flag FLGc is set to ON when the temperatures of the first and second clutches C1 and C2 are substantially the same. Further, the alternate moving start flag FLGc is set to OFF when the temperatures of the first and second clutches C1 and C2 differ from each other. Subsequently, when a determination result of Step 15 is NO (FLGc=OFF), the ECU 40 selects one of the first and second clutches C1 and C2, whose temperature is lower, as the selected clutch (Step 16, S16), and then the ECU 40 moves the process to Step 18 (described later). The temperatures of the first and second clutches C1 and C2 are calculated in Steps 51 and 61 (described later).

On the other hand, when the determination result of Step 15 is YES (FLGc=ON), the ECU retrieves the selected clutch, which is selected when the vehicle is started to move previously, (for example, the first clutch C1) from the RAM 43, and then selects the other clutch (for example, the second clutch C2), which is not the retrieved clutch, as the selected clutch (Step 17, S17). According to the embodiment, the RAM 43 serves as a clutch memorizing means for memorizing the clutch used (selected) when the vehicle is started to move. Subsequently, the ECU 40 moves the process to the next step, Step 18 (S18).

The ECU 40 determines whether or not an application of a braking force to each of the front and rear wheels FR, FL, RR and RL by means of a brake actuator is stopped on the basis of a detection signal outputted from the brake switch SW1 in Step 18. When a determination result of Step 18 is YES (SW1=OFF), the ECU 40 executes a moving start preparation process (Step 19, S19). More specifically, the ECU 40 identifies one of the first and second gear transmission mechanisms 17 and 18 (for example, the first gear transmission mechanism 17), to which the power of the engine 12 is transmitted by means of the selected clutch selected in Step 13, 14, 16 or 17. Then, the ECU 40 controls the driving of the first or second shift stage selection mechanisms 25 or 31 so that the slowest shift stage gear (for example, the first shift stage gear 211) in the identified gear transmission mechanism (for example, the first gear transmission mechanism 17) and the sleeve 24 are engaged with each other and that the shift stage gear (for example, the first shift stage gear 211) and the input shaft (for example, the first input shaft 15) are rotated integrally with each other. Subsequently, the ECU 40 controls the driving of the clutch actuator 20 so that the selected clutch (for example, the first clutch C1) is set to a half-engaged state where the power of the engine 12 is slightly transmitted. Then, the ECU 40 moves the process to Step 20 (described later).

On the other hand, when the determination result of Step 18 is NO (SW1=ON), the ECU 40 returns the process to Step 10 (mentioned above). In a case where the selected clutch (for example, the first clutch C1) is in the half-engaged state, the ECU 40 set the clutch to the disengaged state before moving the process to Step 10.

Subsequently, the ECU 40 determines whether or not the accelerator pedal 11 is being operated in Step 20 (S20) on the basis of the information outputted from the engine ECU 14. When a determination result of Step 20 is NO, the ECU 40 maintains the selected clutch (for example, the first clutch C1) to be in the half-engaged state, and then the ECU 40 moves the process to Step 10 (described later). On the other hand, when the determination result of Step 20 is YES, the ECU 40 determines that the driver intends to start to move the vehicle, and the ECU 40 then executes the vehicle moving starting process in order to start to move the vehicle (Step 21, S21). More specifically, the ECU 40 controls the driving of the clutch actuator 20 so as to switch the selected clutch (for example, the first clutch C1) from the half-engaged state to the engaged state while overwriting the selected clutch in the RAM 43 so that the selected clutch is memorized therein. According to the embodiment, the ECU 40 serves as a clutch controlling means. Accordingly, the power of the engine 12 is transmitted through the power transmission, which includes the selected clutch in the engaged state, to the front wheels FR and FL, thereby the vehicle is started to move. According to the embodiment, the ECU 40 serves as a moving start control means. Then, the ECU 40 ends the routine of the vehicle moving starting process.

When the selected clutch is the second clutch C2, the ECU 40 selects the second shift stage of the automated manual transmission 13, and then the vehicle is started to move. The clutch overheat determination process in above-described Step 10 (a routine of the clutch overheat determination process) will be described hereinafter with reference to a flowchart shown in FIG. 4.

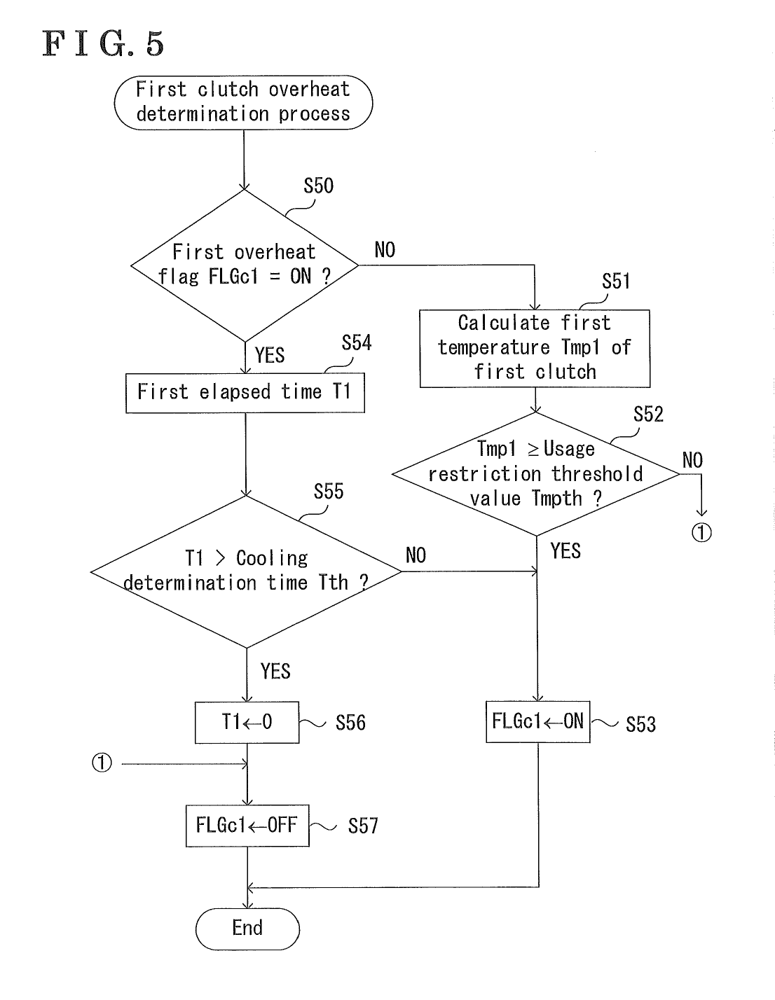

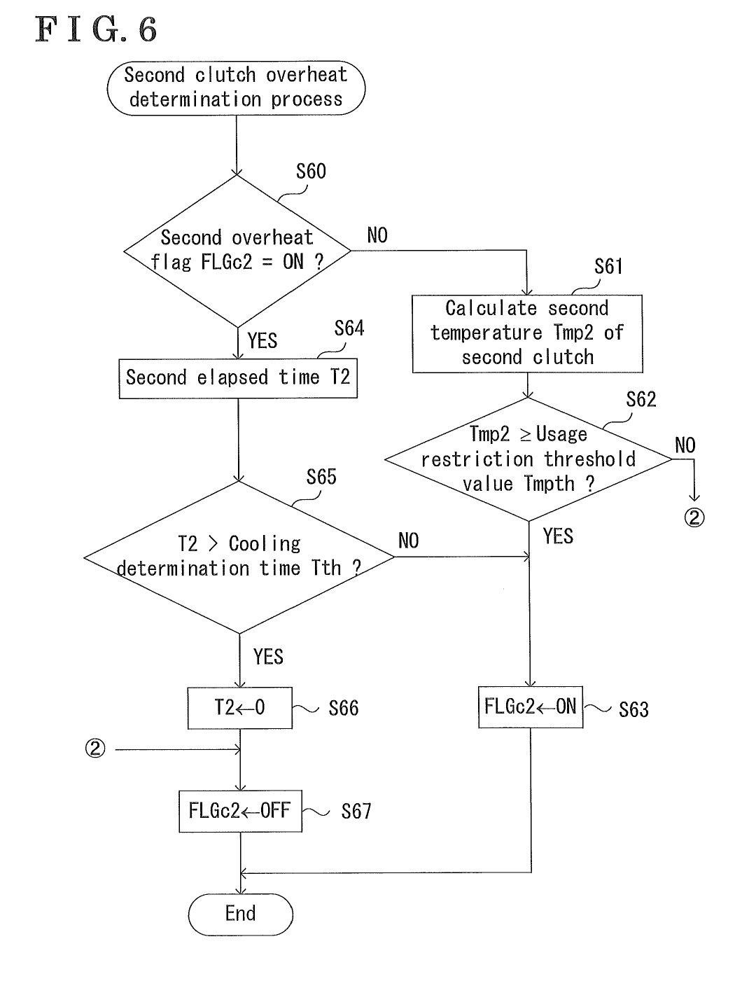

In the routine of the clutch overheat determination process, the ECU 40 executes a first clutch overheat determination process (described in detail in FIG. 5) for determining whether or not the first clutch C1 is in the overheated state (Step 30, S30). According to the first clutch overheat determination process, the first overheat flag FLGc1 is set to ON when the first clutch C1 is in the overheated state, and the first overheat flag FLGc1 is set to OFF when the first clutch C1 is not in the overheated state. Then, the ECU 40 executes a second clutch overheat determination process (described in detail in FIG. 6) for determining whether or not the second clutch C2 is in the overheated state (Step 31, S31). According to the second clutch overheat determination process, the first overheat flag FLGc1 is set to ON when the second clutch C2 is in the overheated state, and the second overheat flag FLGc2 is set to OFF when the second clutch C2 is not in the overheated state. Then, the ECU 40 determines whether or not both of the first and second overheat flags FLGc1 and FLGc2 are ON (Step 32, S32).

When a determination result of Step 32 is NO (at least one of the first and second overheat flags FLGc1 and FLGc2 is OFF), the ECU 40 determines whether or not one of the first and second overheat flags FLGc1 and FLGc2 is OFF (Step 33, S33). Then, when a determination result of Step 33 is YES (the first or second overheat flag FLGc1 or FLGc2 is ON), the ECU 40 sets the single clutch overheat flag FLGk to ON (Step 34, S34) and then resets the frequency of both overheat measurements CK to zero (Step 35, S35). Subsequently, the routine of the clutch overheat determination process is finished. On the other hand, when the determination result of Step 33 is NO (both of the first and second overheat flags FLGc1 and FLGc2 are OFF), the ECU 40 sets the single clutch overheat flag FLGk to OFF (Step 36, S36), and then the ECU 40 moves the process to Step 35.

On the other hand, when the determination result of Step 32 is YES (both of the first and second overheat flags FLGc1 and FLGc2 are ON), the ECU 40 calculates a temperature difference Tdiff between the first and second clutches C1 and C2 (Step 37, S37). Then, the ECU 40 determines whether or not the temperature difference Tdiff is greater than a temperature difference threshold value Tdiffth (Step 38, S38). The temperature difference threshold value Tdiffth, herein, is a standard value used for determining that there is a predetermined difference in temperature between the first and second clutches C1 and C2. The temperature difference threshold value Tdiffth is predetermined on the basis of results of an experiment, simulation, and the like. When a determination result of Step 38 is NO (Tdiff s Tdiffth), the ECU 40 sets the alternate moving start flag FLGc to ON (Step 39, S39). Subsequently, the routing of the clutch overheat determination process is finished.

On the other hand, when the determination result of Step 38 is YES (Tdiff>Tdiffth), the ECU 40 increments the frequency of both overheat measurements by 1 (Step 40, S40). Then, the ECU 40 determines whether or not the frequency of both overheat measurements, which is updated in Step 40, is smaller than the frequency threshold value CKth (Step 41, S41). The frequency threshold value CKth is a standard value for determining whether or not the temperature of the clutch, whose temperature is determined to be higher than that of the other clutch, has dropped sufficiently. The frequency threshold value CKth is predetermined on the basis of an experiment, simulation, and the like.

When a determination result of Step 41 is NO (CK≧CKth), the ECU 40 determines that the temperature of one of the first and second clutches C1 and C2, whose temperature is determined to be higher than that of the other one of the first and second clutches C1 and C2, has dropped sufficiently. Then, the ECU 40 moves the process to above-described Step 39. On the other hand, when the determination result of Step 41 is YES (CK<CKth), the ECU 40 determines that there is a temperature difference between the first and second clutches C1 and C2, and sets the alternate moving start flag FLGc to OFF (Step 42, S42), thereby ending the routine of the clutch overheat determination process.

The first clutch overheat determination process in above-described Step 30 (the routine of the first clutch overheat determination process) will be described hereinafter with reference to a flowchart shown in FIG. 5. According to the first clutch overheat determination process, the ECU 40 determines whether or not the first overheat flag FLGc1 is ON (Step 50, S50). When a determination result of Step 50 is NO (FLGc1=OFF), the ECU 40 calculates the first temperature Tmp1 of the first clutch C1 on the basis of a detection signal, outputted from the first temperature sensor SE4 for the first clutch C1. According to the embodiment, the ECU 40 serves as a clutch temperature calculating means. Then, the ECU 40 determines whether or not the first temperature Tmp1, which is calculated in Step 51 (S51), is equal to or greater than the usage restriction threshold value Tmpth (Step 52, S52). The usage restriction threshold value Tmpth, herein, is a standard value for avoiding an occurrence of a malfunction (for example, thermal deformation of clutch) caused by excessively high temperatures of the first or second clutches C1 or C2. The usage restriction threshold value Tmpth is predetermined on the basis of results of an experiment, simulation, and the like. For example, in a case where there is a possibility of thermal deformation of the first and second clutches C1 and C2 when the temperatures of the first and second clutches C1 and C2 exceed 80 degrees centigrade, the usage restriction threshold value Tmpth may be set to a value lower than 80 degrees centigrade (for example, 60 degrees centigrade, which is lower than the 80 degrees centigrade by 20 degrees).

When a determination result of Step 52 is NO (Temp1<Tempth), the ECU 40 determines that the first clutch C1 is not in the overheated state, and then moves the process to Step 57 (described later). On the other hand, when the determination result of Step 52 is YES, the ECU 40 determines that the first clutch C1 is in the overheated state, and then sets the first overheat flag FLGc1 to ON (Step 53, S53). Subsequently, the first clutch overheat process is finished.

On the other hand, when the determination result of Step 50 is YES (FLGc1=ON), the ECU 40 updates a first elapsed time T1, which is a time elapsed after the first overheat flag FLGc1 is set to ON (Step 54, S54). Then, the ECU 40 determines whether or not the first elapsed time T1, which is updated in Step 54, is greater than a level of a predetermined cooling determination time Tth (Step 55, S55). While the first or second clutch C1 or C2 continues to be in the disengaged state, the heat of the first or second clutch C1 or C2 is released and the first or second temperature Tmp1 or Temp 2 (see FIG. 6) of the first or second clutch C1 or C2 drops. Therefore, according to the embodiment, the cooling determination time Tth is set as a standard value for determining whether or not the temperature of the first or second clutch C1 or C2, which is in the disengaged state, has dropped to the usage restriction threshold value Tmpth or smaller.

Subsequently, when a determination result of Step 55 is NO (T1≦Tth), the ECU 40 determines that the first clutch C1 is still in the overheated state, and then moves the process to above-described Step 53. On the other hand, when the determination result of Step 55 is YES (T1>Tth), the ECU 40 determines that the first clutch C1 is not in the overheated state any more, and resets the first elapsed time T1 to zero (Step 56, S56). Then, the ECU 40 moves the process to Step 57 (S57).

The ECU 40 sets the first overheat flag FLGc1 to OFF in Step 57. Subsequently, the routine of the first clutch overheat determination process is finished. The second clutch overheat determination process in above-described Step 31 (the routine of the second clutch overheat determination process) will be described hereinafter with reference to a flowchart shown in FIG. 6.

According to the second clutch overheat determination process, the ECU 40 determines whether or not the second overheat flag FLGc2 is ON (Step 60, S60). When a determination result of Step 60 is NO (FLGc2=OFF), the ECU 40 calculates the second temperature Tmp2 of the second clutch C2 on the basis of a detection signal, outputted from the second temperature sensor SE5 for the second clutch C2. Then, the ECU 40 determines whether or not the second temperature Tmp2, which is calculated in Step 61 (S61), is equal to or greater than the usage restriction threshold value Tmpth (Step 62, S62). When a determination result of Step 62 is NO (Tmp2<Tmpth), the ECU 40 determines that the second clutch C2 is not in the overheated state, and then moves the process to Step 67 (described later). On the other hand, when the determination result of Step 62 is YES (Tmp2≧Tmpth), the ECU 40 determines that the second clutch C2 is in the overheated state, and sets the second overheat flag FLGc2 to ON (Step 63, S63), and thereby ending the routine of the second clutch overheat determination process.

On the other hand, when the determination result of Step 60 is YES (FLGc2=ON), the ECU 40 updates a second elapsed time T2, which is a time elapsed after the second overheat flag FLGc2 is set to ON (Step 64, S64). Then, the ECU 40 determines whether or not the second elapsed time T2, which is updated in Step 64, is greater than a level of a predetermined cooling determination time Tth (Step 65, S65). When a determination result of Step 65 is NO (T2≦Tth), the ECU 40 determines that the second clutch C2 is still in the overheated state, and then moves the process to above-described Step 63. On the other hand, when the determination result of Step 65 is YES (T2>Tth), the ECU 40 determines that the second clutch C2 is not in the overheated state any more, and resets the second elapsed time T2 to zero (Step 66, S66). Then, the ECU 40 moves the process to Step 67 (S67).

The ECU 40 sets the second overheat flag FLGc2 to OFF in Step 67, and thereby ending the routine of the second clutch overheat determination process. According to the embodiment, the following effects may be obtained.

When the first temperature Tmp1 of the first clutch C1 of the two clutches C1 and C2 is the usage restriction threshold value Tmpth or greater before the vehicle is started to move, the second clutch C2, whose temperature Tmp2 is lower than the usage restriction threshold value Tmpth, is used in order to start to move the vehicle. On the other hand, when only the second temperature Tmp2 of the second clutch C2 is the usage restriction threshold value Tmpth or greater before the vehicle is started to move, the first clutch C1, whose temperature Tmp1 is lower than the usage restriction threshold value Tmpth, is used in order to start to move the vehicle. Therefore, even if one of the first and second clutches C1 and C2 is in the overheated state, the vehicle may be started to move so as to reflect an intention of the driver.

When both of the first and second temperatures Tmp1 and Tmp2 of the first and second clutches C1 and C2 are the usage restriction threshold value Tmpth or greater, and the temperature difference Tmpdiff is smaller than the temperature difference threshold value Tmpdiffth, the first and second temperatures Tmp1 and Tmp2 of the first and second clutches C1 and C2 are determined to be substantially the same level. Then, the clutch, which is not used when the vehicle is started to move previously, is selected, and the vehicle is started to move using the selected clutch. In other words, when both of the first and second clutches C1 and C2 are in the overheated state, it may be prevented that only one of the first and second clutches C1 and C2 is repeatedly selected in order to start to move the vehicle, and that the temperature of only one of the first and second clutches C1 and C2 (for example, the first clutch C1) is increased.

When both of the first and second temperatures Tmp1 and Tmp2 of the first and second clutches C1 and C2 are the usage restriction threshold value Tmpth or greater, and the temperature difference Tmpdiff is the temperature difference threshold value Tmpdiffth or greater, the clutch, whose temperature is lower than that of the other clutch, is selected, and the vehicle is started to move, using the selected clutch. Therefore, a usage of the clutch at a higher temperature (for example, the first clutch C1) is restricted, which allows the clutch at a higher temperature to release the temperature thereof.

According to the embodiment, when both of the first and second temperatures Tmp1 and Tmp2 of the first and second clutches C1 and C2 are smaller than the usage restriction threshold value Tmpth, the first clutch C1 is selected, and the vehicle is started to move using the first clutch C1. On the other hand, when at least one of the first and second temperatures Tmp1 and Tmp2 of the first and second clutches C1 and C2 is greater than the usage restriction threshold value Tmpth, the first and second temperatures Tmp1 and Tmp2 of the first and second clutches C1 and C2 are reflected in the determination of the clutch selection. Therefore, even when at least one of the first and second clutches C1 and C2 is in the overheated state, the vehicle may be started to move so as to reflect an intention of the driver.

The embodiment may be modified as follows. In the first clutch overheat determination process, the first temperature Tmp1 of the first clutch C1 may be also detected even when the first overheat flag FLGc1 is ON. Likewise, in the second clutch overheat determination process, the second temperature Tmp2 of the second clutch C2 may be also detected even when the second overheat flag FLGc2 is ON.

Further, steps 40 and 41 may be omitted. Furthermore, the cooling determination time Tth may be set so as to be a high level when each of the first and second temperatures Tmp1 and Tmp2 of the first and second clutches C1 and C2 is high. In such a case, when the difference between the first and second temperatures Tmp1 and Tmp2 of the first and second clutches C1 and C2 is large, the cooling determination threshold value Tth may be set on the basis of the temperature of the clutch at a higher temperature.

Still further, the first and second temperature sensors SE4 and SE5 for the first and second clutches C1 and C2 may not be mounted on the vehicle. In such a case, the ECU 40 may detect a usage condition of each of the first and second clutches C1 and C2, and thereby estimating (calculating) the first and second temperatures Tmp1 and Tmp2 of the first and second clutches C1 and C2.

According to the embodiment, the control apparatus for the automated manual transmission 13 having the first and second power transmitting units respectively including the first and second clutches C1 and C2 for connecting and disconnecting a power transmission path between the engine 12 and the automated manual transmission 13 and the first and second transmission mechanisms 17 and 18 connected to the corresponding first and second clutches C1 and C2 so as to transmit the power of the engine 12, the control apparatus including the clutch controlling means 40 for controlling switching of one of the first and second clutches C1 and C2, provided to one of the first and second power transmission units, to the engaged state and the other one of the first and second clutches C1 and C2, provided to the other one of the first and second power transmission units, to the disengaged state, in order to transmit the power of the engine 12 to the power transmission units, having the first or second clutch C1 or C2 in the engaged state, when the vehicle is being driven, the clutch temperature calculating means 40 for calculating the first or second temperature Tmp1 or Tmp2 of each of the clutches C1 and C2, and the vehicle moving start controlling means 40 for controlling the moving start of the vehicle so that when the first or second temperature Tmp1 or Tmp2 of one of the first and second clutches C1 and C2, calculated by means of the clutch temperature calculating means 40, is equal to or higher than the predetermined usage restriction threshold value Tmpth, the other one of the first and second clutches C1 and C2 is used so as to transmit the power of the engine 12 to the other one of the first and second power transmission units, having the other one of the first and second clutches C1 and C2.

Accordingly, when the temperature Tmp1 or Tmp2 of one of the first and second clutches C1 and C2 is determined to be the usage restriction threshold value Tmth or greater, one of the first and second clutches C1 and C2 is determined to be in the overheated state and the vehicle is started to move, using the other one of the first and second clutches C1 and C2 which is not in the overheated state. In other words, the clutch, used in order to start to move the vehicle, is selected on the basis of the temperatures Tmp1 and Tmp2 of the first and second clutches C1 and C2. Accordingly, even when at least one of the first and second clutches C1 and C2 is in the overheated state, the vehicle may be started to move so as to reflect an intention of the driver.

According to the embodiment, the control apparatus for the automated manual transmission 13 further including the clutch memorizing means 43 for memorizing the first or second clutch C1 or C2, used when the vehicle is started to move. The vehicle moving start controlling means 40 controls the moving start of the vehicle so that when the first and second temperatures Tmp1 and Tmp2 of both of the first and second clutches C1 and C2, calculated by means of the clutch temperature calculating means 40, are equal to or higher than the predetermined usage restriction threshold value Tmpth, information indicating the first or second clutch C1 or C2, used when the vehicle is started to move previously, is retrieved from the clutch memorizing means 43 and the power of the engine 12 is transmitted to the first or second power transmission unit, having the first or second clutch C1 or C2, which is not used when the vehicle is started to move previously.

Accordingly, when the first and second temperatures Tmp1 and Tmp2 of both of the first and second clutches C1 and C2 are the usage restriction threshold value Tmpth or greater, the vehicle is started to move, using one of the first and second clutches C1 and C2, which is not used in the previous vehicle moving start. In other words, it may be prevented that only one of the first and second clutches C1 and C2 is selected in order to start to move the vehicle, and that the temperature Tmp1 or Tmp2 of only one of the first and second clutches C1 and C2 (for example, the first clutch C1 is increased.

According to the embodiment, the vehicle moving start controlling means 40 controls the moving start of the vehicle so that when the first and second temperatures Tmp1 and Tmp2 of both of the first and second clutches C1 and C2, calculated by means of the clutch temperature calculating means 40, are equal to or higher than the predetermined usage restriction threshold value Tmpth, and when the first and second temperatures Tmp1 and Tmp2 of the first and second clutches C1 and C2 differ from each other, the power of the engine 12 is transmitted to the first and second power transmission unit, having the first or second clutch whose temperature Tmp1 or Tmp2 is lower than the first or second temperature Tmp1 or Tmp2 of the other one of the first and second clutches C1 and C2.

Accordingly, when the first and second temperatures Tmp1 and Tmp2 of both of the first and second clutches C1 and C2 are the usage restriction threshold value Tmpth or greater, and when the first and second temperatures Tmp1 and Tmp2 of the first and second clutches C1 and C2 differ from each other, the vehicle is started to move, using one of the first and second clutches C1 and C2 at a lower temperature. Therefore, a usage of one of the first and second clutches C1 and C2, whose temperature Tmp1 or Tmp2 is higher than the other one of the first and second clutches C1 and C2, is restricted, which allows one of the first and second clutches C1 and C2, whose temperature Tmp1 or Tmp2 is higher, to release the temperature Tmp1 or Tmp2 thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A control apparatus for an automated manual transmission having a plurality of power transmitting units respectively including clutches for connecting and disconnecting a power transmission path between a power source and the automated manual transmission and transmission mechanisms connected to the corresponding clutches so as to transmit a power of the power source, the control apparatus comprising:
a clutch controlling means for controlling switching of one of the clutches, provided to one of the power transmission units, to an engaged state and the other one of the clutches, provided to the other one of the power transmission units, to a disengaged state, in order to transmit the power of the power source to the power transmission units, having the clutch in the engaged state, when a vehicle is being driven;
a clutch temperature calculating means for calculating a temperature of each of the clutches; and
a vehicle moving start controlling means for controlling a moving start of the vehicle so that when the temperature of one of the clutches, calculated by means of the clutch temperature calculating means, is equal to or higher than a predetermined usage restriction threshold value, the other one of the clutches is used so as to transmit the power of the power source to the other one of the power transmission units, having the other one of the clutches.

2. The control apparatus for the automated manual transmission according to claim 1, the control apparatus further including
a clutch memorizing means for memorizing the clutch, used when the vehicle is started to move, wherein
the vehicle moving start controlling means controls the moving start of the vehicle so that when the temperatures of both of the clutches, calculated by means of the clutch temperature calculating means, are equal to or higher than the predetermined usage restriction threshold value, information indicating the clutch, used when the vehicle is started to move previously, is retrieved from the clutch memorizing means and the power of the power source is transmitted to the power transmission units, having the clutch, which is not used when the vehicle is started to move previously.

3. The control apparatus for the automated manual transmission according to claim 1, wherein
the vehicle moving start controlling means controls the moving start of the vehicle so that when the temperatures of both of the clutches, calculated by means of the clutch temperature calculating means, are equal to or higher than the predetermined usage restriction threshold value, and when the temperatures of the clutches differ from each other, the power of the power source is transmitted to the power transmission unit, having the clutch whose temperature is lower than the temperature of the other clutch.

4. The control apparatus for the automated manual transmission according to claim 2, wherein
the vehicle moving start controlling means controls the moving start of the vehicle so that when the temperatures of both of the clutches, calculated by means of the clutch temperature calculating means, are equal to or higher than the predetermined usage restriction threshold value, and when the temperatures of the clutches differ from each other, the power of the power source is transmitted to the power transmission unit, having the clutch whose temperature is lower than the temperature of the other clutch.
